(19) United States
(12) Patent Application Publication
(10) Pub. No.: US 2026/0186314 A1
(43) Pub. Date: Jul. 2, 2026

(54) Film Stack Structure of Polarizing Beam Splitting and Polarizing Beam Splitter

(71) Applicant: Vactronics Technologies Inc., MIAOLI COUNTY (TW)

(72) Inventors: Hsang-Yang LIN, MIAOLI COUNTY (TW); Cheng-Tang MU, MIAOLI COUNTY (TW); Hung-Jen PAN, MIAOLI COUNTY (TW)

(21) Appl. No.: 19/007,963

(22) Filed: Jan. 2, 2025

(51) Int. Cl. G02B 27/28; G02B 5/30

(52) U.S. Cl. CPC G02B 27/283; G02B 5/3041

(57) ABSTRACT

A film stack structure of polarizing beam splitting includes a plurality of high refractive index layers and a plurality of low refractive index layers that are alternately stacked. A transmittance T1 of the film stack structure of polarizing beam splitting for first polarized light in a specific wavelength band at an incident angle of 45 degrees and a transmittance T2 of the film stack structure of polarizing beam splitting for second polarized light in the specific wavelength band at an incident angle of 45 degrees meet the conditional formula, T2/T1>1000, and the polarization direction of the first polarized light is perpendicular to that of the second polarized light.

### BACKGROUND

### Field of the Invention

The present invention relates to a beam splitter, and more particularly to a polarizing beam splitting film stack structure and a polarizing beam splitter.

### Description of Related Art

A polarizing prism as a polarizing beam splitter is an optical component specifically designed to split non-polarized light into a reflected S-linearly polarized light beam (i.e., S-wave) and a transmitted P-linearly polarized light beam (i.e., P-wave), with each of the S-linearly polarized light beam and the P-linearly polarized light beam accounting for 50%.

However, such polarizing beam splitters can split unpolarized light into S-waves and P-waves and make the S-waves and P-waves exit from the polarizing beam splitter along different paths to make only one type of polarized light (either the S-wave or the P-wave) passing through the polarizing beam splitter, but they have large volumes to be reckoned with, which go against their application.

### SUMMARY

For this reason, the objective of the present invention is to provide a film stack structure of polarizing beam splitting and a polarizing beam splitter, which can overcome the problem in the prior art that the conventional polarizing beam splitter only can split light into two linearly polarized light components orthogonal to each other to let one of the linearly polarized light components pass therethrough, but has relatively a larger volume leading to a handicap to its application. For achieving single polarization for the transmitted light by using the film stack structure in conjunction with a substrate instead of polarizing prisms, the present invention can greatly reduce the volume of the polarizing beam splitter, leading to a benefit to its application. Moreover, it may be possible in the present invention to make the transmittance of the specific polarized light in a specific wavelength band at the incident angle of 45 degrees approach or to be 100%.

According to an embodiment provided by the present invention, a film stack structure of polarizing beam splitting is suitable for being arranged on a substrate and includes: a plurality of film layers, including a plurality of high refractive index layers and a plurality of low refractive index layers, and the high refractive index layers and the low refractive index layers being alternately stacked on the substrate. The transmittance of the film stack structure of polarizing beam splitting for first polarized light in a specific wavelength band at an incident angle of 45 degrees is defined as T1, a transmittance of the film stack structure of polarizing beam splitting for second polarized light in the specific wavelength band at an incident angle of 45 degrees is defined as T2, a polarization direction of the first polarized light is perpendicular to that of the second polarized light, and the following conditional formula is satisfied: T2/T1>1000.

With the above-mentioned film layer configuration, the incident light will be split into the first polarized light and the second polarized light whose polarization directions are perpendicular to each other, when the incident light is projected at an incident angle of 45 degrees onto either of the top surface and the bottom surface of the film stack structure of polarizing beam splitting of the present invention, and one of the first and second polarized light will be reflected while the other of the first and second polarized light will pass through the film stack structure of polarizing beam splitting.

In another embodiment, the number of the high refractive index layers is greater than that of the low refractive index layers.

In yet another embodiment, the film layer closest to the substrate among the plurality of film layers is the high refractive index layer, and the film layer farthest from the substrate among the plurality of film layers is also the high refractive index layer.

In yet another embodiment, among the plurality of film layers, the thickness of the film layer closest to the substrate is greater than the thickness of the film layer farthest from the substrate.

In yet another embodiment, the high refractive index layers are titanium dioxide layers, and the low refractive index layers are silicon dioxide layers.

In yet another embodiment, the specific wavelength band is the band from 681 nm to 927 nm. Alternatively, the specific wavelength band is the band from 723 nm to 991 nm.

Moreover, the present invention also provides a film stack structure of polarizing beam splitting according to an embodiment, which is suitable for being arranged on a substrate and includes: a plurality of film layers, including a plurality of high refractive index layers and a plurality of low refractive index layers. The high refractive index layers and the low refractive index layers are alternately stacked on the substrate; and the transmittance of the film stack structure of polarizing beam splitting for first polarized light in the wavelength band from 871 nm to 927 nm at an incident angle of 45 degrees is lower than 0.1%, while the transmittance of the film stack structure of polarizing beam splitting for second polarized light in the wavelength band from 871 nm to 927 nm at an incident angle of 45 degrees is higher than 0.1%.

With the above-mentioned film layer configuration, the incident light will be split into the first polarized light and the second polarized light whose polarization directions are perpendicular to each other, when the incident light is projected at an incident angle of 45 degrees onto either of the top surface and the bottom surface of the film stack structure of polarizing beam splitting of the present invention, and one of the first and second polarized light will be reflected while the other of the first and second polarized light will pass through the film stack structure of polarizing beam splitting.

In another embodiment, the number of the high refractive index layers is greater than the number of the low refractive index layers.

In yet another embodiment, among the plurality of film layers, the film layer closest to the substrate is the high refractive index layer, and the film layer farthest from the substrate is also the high refractive index layer.

In yet another embodiment, among the plurality of film layers, a film layer with the largest thickness is the film layer that is the second farthest from the substrate.

In yet another embodiment, among the plurality of film layers, a film layer with the smallest thickness is the film layer farthest from the substrate.

In yet another embodiment, among the plurality of film layers, the thickness of the film layer closest to the substrate is greater than the thickness of the film layer farthest from the substrate.

In yet another embodiment, among the plurality of film layers, the thickness of a film layer that is the second closest to the substrate is smaller than that of a film layer that is the second farthest from the substrate.

In yet another embodiment, among two adjacent film layers of the plurality of film layers, the thickness ratio of the film layer close to the substrate to the film layer away from the substrate is within the range of 0.34 to 9.10.

In yet another embodiment, for a low refractive index layer and a high refractive index layer adjacent to the low refractive index layer among the plurality of film layers, the thickness ratio of the low refractive index layer to the high refractive index layer is within the range of 0.41 to 2.70.

In yet another embodiment, the high refractive index layers are titanium dioxide layers, and the low refractive index layers are silicon dioxide layers.

In yet another embodiment, the specific wavelength band is the band from 681 nm to 927 nm.

Furthermore, the present invention also provides another film stack structure of polarizing beam splitting according to an embodiment, which is suitable for being arranged on a substrate and includes: a plurality of film layers, including a plurality of high refractive index layers and a plurality of low refractive index layers. The high refractive index layers and the low refractive index layers are alternately stacked on the substrate; and the transmittance of the film stack structure of polarizing beam splitting for first polarized light in the wavelength band from 931 nm to 991 nm at an incident angle of 45 degrees is lower than 0.1%, while the transmittance of the film stack structure of polarizing beam splitting for second polarized light in the wavelength band from 931 nm to 991 nm at an incident angle of 45 degrees is higher than 0.1%.

With the above-mentioned film layer configuration, the incident light will be split into the first polarized light and the second polarized light whose polarization directions are perpendicular to each other, when the incident light is projected at an incident angle of 45 degrees onto either of the top surface and the bottom surface of the film stack structure of polarizing beam splitting of the present invention, and one of the first and second polarized light will be reflected while the other of the first and second polarized light will pass through the film stack structure of polarizing beam splitting.

In another embodiment, the number of the high refractive index layers is greater than that of the low refractive index layers.

In yet another embodiment, among the plurality of film layers, the film layer closest to the substrate is the high refractive index layer, and the film layer farthest from the substrate is also the high refractive index layer.

In yet another embodiment, among the plurality of film layers, the film layer with the smallest thickness is a film layer that is the second farthest from the substrate.

In yet another embodiment, among the plurality of film layers, the thickness of the film layer closest to the substrate is greater than that of the film layer farthest from the substrate.

In yet another embodiment, among the plurality of film layers, the thickness of a film layer that is the second closest to the substrate is greater than the thickness of a film layer that is the second farthest from the substrate.

In yet another embodiment, among two adjacent film layers of the plurality of film layers, the thickness ratio of the film layer close to the substrate to the film layer away from the substrate is within the range of 0.30 to 2.70.

In yet another embodiment, for a low refractive index layer and a high refractive index layer adjacent to the low refractive index layer among the plurality of film layers, the thickness ratio of the low refractive index layer to the high refractive index layer is within the range of 0.74 to 2.27.

In yet another embodiment, the high refractive index layers are titanium dioxide layers, and the low refractive index layers are silicon dioxide layers.

In yet another embodiment, the specific wavelength band is the band from 723 nm to 991 nm.

In addition, the present invention also provides a polarizing beam splitter according to an embodiment, which includes a substrate and the above-mentioned film stack structure of polarizing beam splitting, and the film stack structure of polarizing beam splitting is arranged on the substrate.

In this way, the optical element adopting the film stack structure of polarizing beam splitting of the present invention can be used as a polarizing beam splitter that only allows P-wave to pass through.

### BRIEF DESCRIPTION OF THE DRAWINGS

After studying the detailed description in combination with the attached drawings below, other aspects of the present invention and its advantages will be found:

FIG. 1 is a schematic structural diagram of a polarizing beam splitter according to an embodiment of the present invention;

FIG. 2 is a spectrogram of a transmittance simulation test conducted at an incident angle of 0 degree on the film stack structure of polarizing beam splitting of the polarizing beam splitter in FIG. 1;

FIG. 3 is a spectrogram of a transmittance simulation test conducted at an incident angle of 45 degrees on the film stack structure of polarizing beam splitting of the polarizing beam splitter in FIG. 1;

FIG. 4 is a schematic structural diagram of a polarizing beam splitter according to another embodiment of the present invention;

FIG. 5 is a spectrogram of a transmittance simulation test conducted at an incident angle of 0 degree on the film stack structure of polarizing beam splitting of the polarizing beam splitter in FIG. 4; and

FIG. 6 is a spectrogram of a transmittance simulation test conducted at an incident angle of 45 degrees on the film stack structure of polarizing beam splitting of the polarizing beam splitter in FIG. 4.

### DETAILED DESCRIPTION

According to an embodiment provided by the present invention, a polarizing beam splitter includes a substrate and a film stack structure of polarizing beam splitting, and this film stack structure of polarizing beam splitting is disposed on the substrate. The substrate is, for example but not limited to, a glass substrate.

The film stack structure of polarizing beam splitting in one aspect includes a plurality of film layers, which includes a plurality of high refractive index layers and a plurality of low refractive index layers. These high refractive index layers and these low refractive index layers are alternately stacked on the substrate. Here, the high refractive index layer refers to a film layer made of a material with a higher refractive index than that of the low refractive index layer. Correspondingly, the low refractive index layer here refers to a film layer made of a material with a lower refractive index than that of the high refractive index layer.

Optionally, the transmittance of the film stack structure of polarizing beam splitting for the first polarized light in a specific wavelength band at an incident angle of 45 degrees is defined as T1, and the transmittance of the film stack structure of polarizing beam splitting for the second polarized light in this specific wavelength band at an incident angle of 45 degrees is defined as T2. The polarization direction of the first polarized light is perpendicular to that of the second polarized light, and the following conditional formula is satisfied: T2/T1>1000.

Optionally, the above-mentioned specific wavelength band is the band from 681 nm to 927 nm. Alternatively, the above-mentioned specific wavelength band is the band from 723 nm to 991 nm.

Optionally, the transmittance of the film stack structure of polarizing beam splitting for the first polarized light in the wavelength band from 871 nm to 927 nm at an incident angle of 45 degrees is lower than 0.1%, while the transmittance of the film stack structure of polarizing beam splitting for the second polarized light in the wavelength band from 871 nm to 927 nm at an incident angle of 45 degrees is higher than 0.1%.

Optionally, the number of the high refractive index layers is greater than that of the low refractive index layers.

Optionally, among the plurality of film layers, the film layer closest to the substrate is a high refractive index layer, and the film layer farthest from the substrate is also a high refractive index layer.

Optionally, among the plurality of film layers, the film layer with the largest thickness is the film layer that is the second farthest from the substrate.

Optionally, among the plurality of film layers, the film layer with the smallest thickness is the film layer that is the farthest from the substrate.

Optionally, among the plurality of film layers, the thickness of the film layer closest to the substrate is greater than that of the film layer farthest from the substrate.

Optionally, among the plurality of film layers, the thickness of the film layer that is the second closest to the substrate is smaller than that of the film layer that is the second farthest from the substrate.

Optionally, among two adjacent film layers of the plurality of film layers, the thickness ratio of the film layer close to the substrate to the film layer away from the substrate is within the range of 0.34 to 9.10.

Optionally, for a low refractive index layer and a high refractive index layer adjacent to the low refractive index layer among the plurality of film layers, the thickness ratio of the low refractive index layer to the high refractive index layer is within the range of 0.41 to 2.70.

Optionally, the high refractive index layers are titanium dioxide layers, and the low refractive index layers are silicon dioxide layers.

Optionally, the transmittance of the film stack structure of polarizing beam splitting for the first polarized light in the wavelength band from 931 nm to 991 nm at an incident angle of 45 degrees is lower than 0.1%, while the transmittance of the film stack structure of polarizing beam splitting for the second polarized light in the wavelength band from 931 nm to 991 nm at an incident angle of 45 degrees is higher than 0.1%.

Optionally, among the plurality of film layers, the film layer with the smallest thickness is the film layer that is the second farthest from the substrate.

Optionally, among the plurality of film layers, the thickness of the film layer that is the second closest to the substrate is greater than that of the film layer that is the second farthest from the substrate.

Optionally, among two adjacent film layers of the plurality of film layers, the thickness ratio of the film layer close to the substrate to the film layer away from the substrate is within the range of 0.30 to 2.70.

Optionally, for a low refractive index layer and a high refractive index layer adjacent to the low refractive index layer among the plurality of film layers, the thickness ratio of the low refractive index layer to the high refractive index layer is within the range of 0.74 to 2.27.

Optionally, the high refractive index layers are titanium dioxide layers, and the low refractive index layers are silicon dioxide layers.

The following is a detailed description of different examples of film stack structures of polarizing beam splitting.

### Example 1

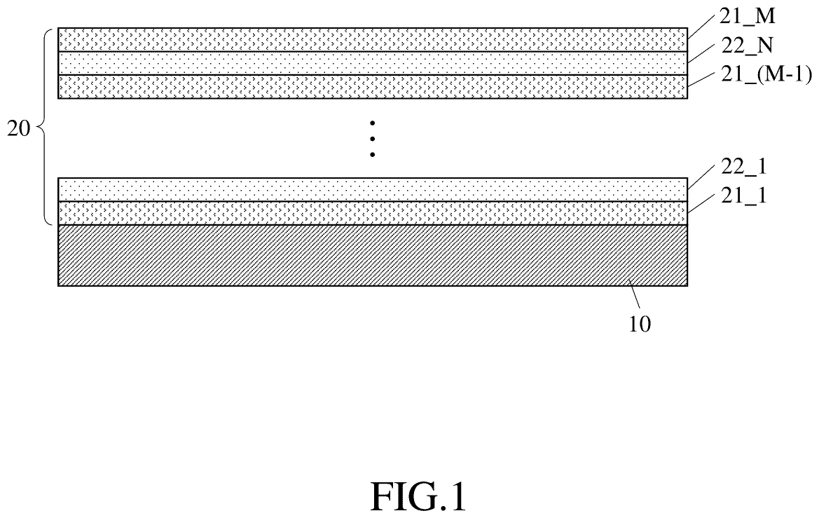

Please refer to FIGS. 1 to 3, a film stack structure of polarizing beam splitting 20 is suitable for being disposed on a substrate 10 and includes 53 film layers. These 53 film layers include a plurality of high refractive index layers (i.e., film layers 21_1 to 21_M) and a plurality of low refractive index layers (i.e., film layers 22_1 to 22_N). These high refractive index layers and these low refractive index layers are alternately stacked on the substrate 10. In this example, M is 27 and N is 26. The high refractive index layer is, for example but not limited to, a titanium dioxide layer (TiO2), and the low refractive index layer is, for example but not limited to, a silicon dioxide layer (SiO2).

For details of the film stack structure of polarizing beam splitting 20, please refer to Table 1, the first ratio refers to the thickness ratio of the film layer close to the substrate 10 to the film layer away from the substrate 10 among two adjacent film layers (for example, the thickness ratio of film layer 22_N to film layer 21_M) of the film layers 21_1 to 21_M and 22_1 to 22_N, and the second ratio refers to the thickness ratio of the low refractive index layer to the high refractive index layer (for example, the thickness ratio of film layer 22_N to film layer 21_(M−1)) adjacent to the low refractive index layer among the film layers 21_1 to 21_M and 22_1 to 22_N.

TABLE 1

| Film layer# | material | thickness(nm) | First ratio | Second ratio |
|---|---|---|---|---|
| 1 | TiO2 | 94.47 | 0.80 | 1.24 |
| 2 | SiO2 | 117.41 | 2.93 | |
| 3 | TiO2 | 40.06 | 0.79 | 1.27 |
| 4 | SiO2 | 50.82 | 1.20 | |
| 5 | TiO2 | 42.44 | 0.37 | 2.70 |
| 6 | SiO2 | 114.67 | 1.33 | |
| 7 | TiO2 | 86.26 | 0.58 | 1.72 |
| 8 | SiO2 | 148.68 | 1.63 | |
| 9 | TiO2 | 91.44 | 0.60 | 1.67 |
| 10 | SiO2 | 152.45 | 1.68 | |
| 11 | TiO2 | 90.65 | 0.60 | 1.68 |
| 12 | SiO2 | 152.31 | 1.69 | |
| 13 | TiO2 | 89.87 | 0.59 | 1.69 |
| 14 | SiO2 | 152.06 | 1.70 | |
| 15 | TiO2 | 89.36 | 0.59 | 1.70 |
| 16 | SiO2 | 151.72 | 1.70 | |
| 17 | TiO2 | 89.43 | 0.59 | 1.70 |
| 18 | SiO2 | 151.99 | 1.68 | |
| 19 | TiO2 | 90.51 | 0.59 | 1.69 |
| 20 | SiO2 | 153.21 | 1.67 | |
| 21 | TiO2 | 91.82 | 0.60 | 1.67 |
| 22 | SiO2 | 153.27 | 1.69 | |
| 23 | TiO2 | 90.74 | 0.59 | 1.68 |
| 24 | SiO2 | 152.7 | 1.69 | |
| 25 | TiO2 | 90.1 | 0.59 | 1.70 |
| 26 | SiO2 | 153.17 | 1.70 | |
| 27 | TiO2 | 90.35 | 0.59 | 1.70 |
| 28 | SiO2 | 153.65 | 1.69 | |
| 29 | TiO2 | 90.72 | 0.59 | 1.69 |
| 30 | SiO2 | 153.03 | 1.69 | |
| 31 | TiO2 | 90.52 | 0.60 | 1.68 |
| 32 | SiO2 | 151.91 | 1.68 | |
| 33 | TiO2 | 90.47 | 0.59 | 1.69 |
| 34 | SiO2 | 152.82 | 1.68 | |
| 35 | TiO2 | 91.07 | 0.59 | 1.69 |
| 36 | SiO2 | 153.9 | 1.70 | |
| 37 | TiO2 | 90.61 | 0.59 | 1.68 |
| 38 | SiO2 | 152.6 | 1.70 | |
| 39 | TiO2 | 89.52 | 0.59 | 1.68 |
| 40 | SiO2 | 150.8 | 1.70 | |
| 41 | TiO2 | 88.74 | 0.59 | 1.69 |
| 42 | SiO2 | 149.54 | 1.67 | |
| 43 | TiO2 | 89.38 | 0.60 | 1.68 |
| 44 | SiO2 | 149.95 | 1.57 | |
| 45 | TiO2 | 95.42 | 0.62 | 1.61 |
| 46 | SiO2 | 153.8 | 1.85 | |
| 47 | TiO2 | 83.01 | 0.71 | 1.41 |
| 48 | SiO2 | 116.7 | 0.97 | |
| 49 | TiO2 | 120.06 | 2.42 | 0.41 |
| 50 | SiO2 | 49.53 | 0.34 | |
| 51 | TiO2 | 147.6 | 0.88 | 1.14 |
| 52 | SiO2 | 168.28 | 9.10 | |
| 53 | TiO2 | 18.49 | — | — |

Among the film layers 21_1 to 21_M and 22_1 to 22_N, it can be seen from Table 1 that: the film layer (i.e., the first film layer (i.e., the film layer 21_1)) closest to the substrate 10 is a high refractive index layer, and the film layer (i.e., the fifty-third film layer (i.e., the film layer 21_M)) farthest from the substrate 10 is also a high refractive index layer; the film layer with the largest thickness is the film layer (i.e., the fifty-second film layer (i.e., the film layer 22_N)) that is the second farthest from the substrate 10; the film layer with the smallest thickness is the film layer farthest from the substrate 10; the thickness of the film layer closest to the substrate 10 is greater than that of the film layer farthest from the substrate 10; the thickness of the film layer (i.e., the second film layer (i.e., the film layer 22_1)) that is the second closest to the substrate 10 is smaller than that of the film layer that is the second farthest from the substrate 10; among two adjacent film layers, the thickness ratio of the film layer close to the substrate to the film layer away from the substrate is within the range of 0.34 to 9.10; and the thickness ratio of a low refractive index layer to the high refractive index layer adjacent to the low refractive index layer is within the range of 0.41 to 2.70.

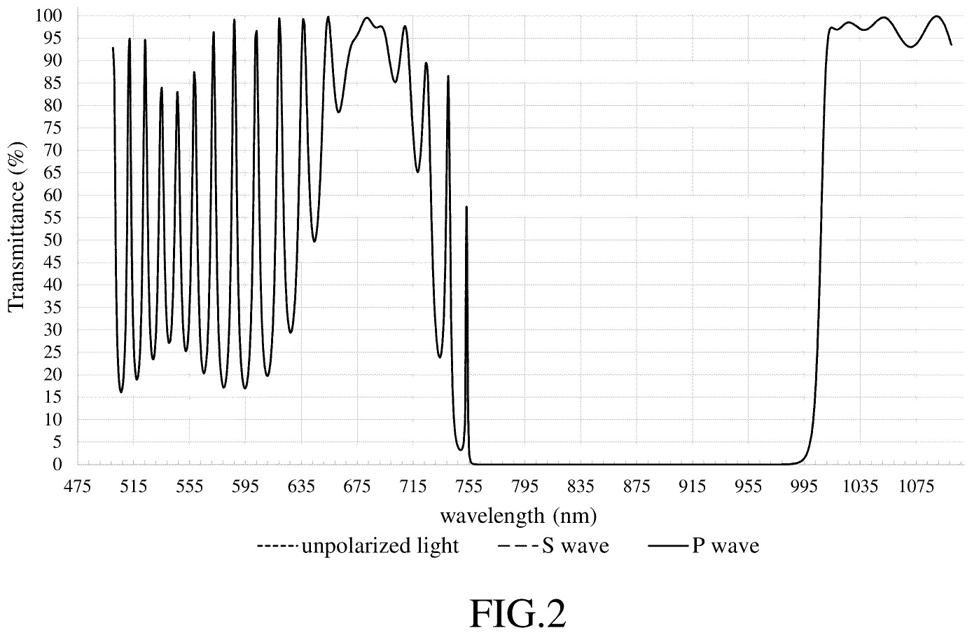

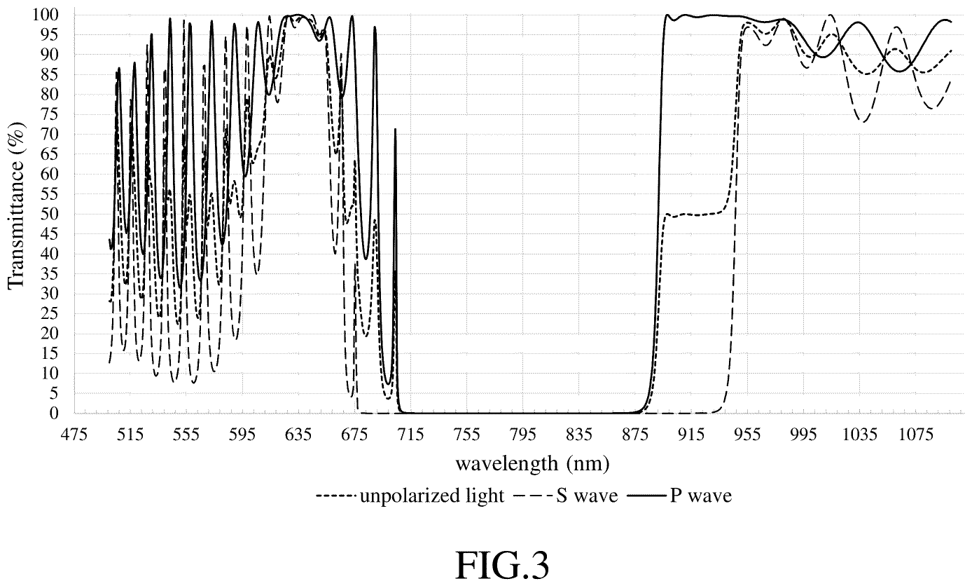

The following is a transmittance simulation test on the film stack structure of polarizing beam splitting 20 in Table 1. The film stack structure of polarizing beam splitting 20 is placed in an atmospheric environment, and then light with a reference wavelength of 550 nm is illuminated from above (i.e., above the drawing) at incident angles of 0° and 45° respectively, and the test results corresponding to the incident angle of 0° as shown in FIG. 2 and the test results corresponding to the incident angle of 45° as shown in FIG. 3 are obtained. In FIGS. 2 and 3, the short dotted line represents the spectral curve of unpolarized light, the long dotted line represents the spectral curve of the S-wave (for example, the first polarized light) in the light, and the solid line represents the spectral curve of the P-wave (for example, the second polarized light) in the light.

It can be seen from FIG. 2 that the spectral curves of unpolarized light, the S-wave, and the P-wave completely coincide. The transmittance of unpolarized light, the S-wave, and the P-wave in the wavelength band from 755 nm to 993 nm at an incident angle of 0 degree is lower than 1%, the transmittance in the wavelength band from 759 nm to 984 nm at an incident angle of 0 degree is lower than 0.1%, and even the transmittance in the wavelength band from 765 nm to 969 nm at an incident angle of 0 degree is 0%.

It can be seen from FIG. 3 that the transmittance of unpolarized light in the wavelength band from 707 nm to 881 nm at an incident angle of 45 degrees is lower than 1%, the transmittance in the wavelength band from 710 nm to 873 nm at an incident angle of 45 degrees is lower than 0.1%, and the transmittance in the wavelength band from 717 nm to 859 nm at an incident angle of 45 degrees is 0%; the transmittance of the S-wave in the wavelength band from 678 nm to 934 nm at an incident angle of 45 degrees is lower than 1%, the transmittance in the wavelength band from 680 nm to 927 nm at an incident angle of 45 degrees is lower than 0.1%, and even the transmittance in the wavelength band from 684 nm to 914 nm at an incident angle of 45 degrees is 0%; the transmittance of the P-wave in the wavelength band from 708 nm to 879 nm at an incident angle of 45 degrees is lower than 1%, the transmittance in the wavelength band from 712 nm to 870 nm at an incident angle of 45 degrees is lower than 0.1%, and even the transmittance in the wavelength band from 720 nm to 855 nm at an incident angle of 45 degrees is 0%. In particular, the transmittance of the S-wave in the wavelength band from 871 nm to 927 nm at an incident angle of 45 degrees is lower than 0.1%, but the transmittance of the P-wave in the wavelength band from 871 nm to 927 nm at an incident angle of 45 degrees is higher than 0.1%, and even the transmittance of the P-wave in the wavelength band from 896 nm to 927 nm at an incident angle of 45 degrees is as high as over 99%. Moreover, the transmittance T1 of the film stack structure of polarizing beam splitting 20 for the S-wave in the wavelength band from 681 nm to 927 nm at an incident angle of 45 degrees and the transmittance T2 of the film stack structure of polarizing beam splitting 20 for the P-wave in the wavelength band from 681 nm to 927 nm at an incident angle of 45 degrees satisfy the following conditional formula: T2/T1>1000.

It can be seen from this that unpolarized light in the wavelength band from 681 nm to 927 nm being projected onto the film stack structure of polarizing beam splitting 20 at an incident angle of 45 degrees could be split into the P-wave and the S-wave, and the S-wave will be reflected while the P-wave will pass through the film stack structure of polarizing beam splitting 20. In this way, an optical element using the film stack structure of polarizing beam splitting 20 can serve as a polarizing beam splitter that only allows the P-wave to pass through.

### Example 2

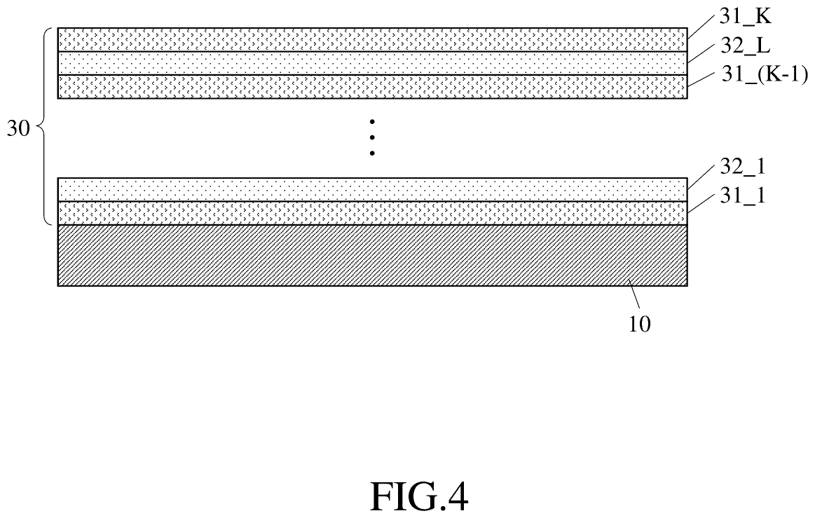

Please refer to FIGS. 3 to 6, a film stack structure of polarizing beam splitting 30 is suitable for being disposed on a substrate 10 and includes 55 film layers. These 55 film layers include a plurality of high refractive index layers (i.e., film layers 31_1 to 31_K) and a plurality of low refractive index layers (i.e., film layers 32_1 to 32_L). These high refractive index layers and these low refractive index layers are alternately stacked on the substrate 10. In this example, K is 28 and L is 27. The high refractive index layer is, for example but not limited to, a titanium dioxide layer, and the low refractive index layer is, for example but not limited to, a silicon dioxide layer.

For details of the film stack structure of polarizing beam splitting 30, please refer to Table 2. The definition of Table 2 can refer to the definition of Table 1, and it will not be repeated here.

TABLE 2

| Film layer# | material | thickness(nm) | First ratio | Second ratio |
|---|---|---|---|---|
| 1 | TiO2 | 102.31 | 1.22 | 0.82 |
| 2 | SiO2 | 84.05 | 2.63 | |
| 3 | TiO2 | 31.98 | 0.91 | 1.10 |
| 4 | SiO2 | 35.3 | 0.54 | |
| 5 | TiO2 | 65.88 | 0.44 | 2.27 |
| 6 | SiO2 | 149.73 | 1.63 | |
| 7 | TiO2 | 91.66 | 0.58 | 1.71 |
| 8 | SiO2 | 157.06 | 1.68 | |
| 9 | TiO2 | 93.58 | 0.58 | 1.73 |
| 10 | SiO2 | 161.6 | 1.68 | |
| 11 | TiO2 | 96.38 | 0.58 | 1.71 |
| 12 | SiO2 | 164.85 | 1.70 | |
| 13 | TiO2 | 97.06 | 0.60 | 1.68 |
| 14 | SiO2 | 162.78 | 1.71 | |
| 15 | TiO2 | 95.26 | 0.59 | 1.69 |
| 16 | SiO2 | 160.99 | 1.70 | |
| 17 | TiO2 | 94.77 | 0.59 | 1.71 |
| 18 | SiO2 | 161.89 | 1.69 | |
| 19 | TiO2 | 95.99 | 0.58 | 1.72 |
| 20 | SiO2 | 164.78 | 1.68 | |
| 21 | TiO2 | 98.01 | 0.59 | 1.69 |
| 22 | SiO2 | 165.19 | 1.72 | |
| 23 | TiO2 | 96.14 | 0.59 | 1.69 |
| 24 | SiO2 | 162.37 | 1.70 | |
| 25 | TiO2 | 95.3 | 0.59 | 1.71 |
| 26 | SiO2 | 162.77 | 1.68 | |
| 27 | TiO2 | 96.76 | 0.59 | 1.70 |
| 28 | SiO2 | 164.23 | 1.70 | |
| 29 | TiO2 | 96.77 | 0.59 | 1.69 |
| 30 | SiO2 | 163.55 | 1.70 | |
| 31 | TiO2 | 96.24 | 0.59 | 1.70 |
| 32 | SiO2 | 163.99 | 1.69 | |
| 33 | TiO2 | 96.96 | 0.59 | 1.70 |
| 34 | SiO2 | 164.8 | 1.70 | |
| 35 | TiO2 | 97.2 | 0.59 | 1.69 |
| 36 | SiO2 | 164.57 | 1.71 | |
| 37 | TiO2 | 96.46 | 0.60 | 1.68 |
| 38 | SiO2 | 161.89 | 1.72 | |
| 39 | TiO2 | 94.24 | 0.59 | 1.68 |
| 40 | SiO2 | 158.66 | 1.69 | |
| 41 | TiO2 | 93.74 | 0.58 | 1.73 |
| 42 | SiO2 | 162.3 | 1.63 | |
| 43 | TiO2 | 99.29 | 0.58 | 1.71 |
| 44 | SiO2 | 170.23 | 1.74 | |
| 45 | TiO2 | 97.69 | 0.61 | 1.65 |
| 46 | SiO2 | 161.18 | 1.72 | |
| 47 | TiO2 | 93.47 | 0.59 | 1.69 |
| 48 | SiO2 | 158.21 | 1.69 | |
| 49 | TiO2 | 93.89 | 0.60 | 1.67 |
| 50 | SiO2 | 156.85 | 1.95 | |
| 51 | TiO2 | 80.52 | 0.88 | 1.14 |
| 52 | SiO2 | 91.85 | 2.70 | |
| 53 | TiO2 | 33.98 | 1.35 | 0.74 |
| 54 | SiO2 | 25.25 | 0.30 | |
| 55 | TiO2 | 85.3 | — | — |

Among the film layers 31_1 to 31_K and 32_1 to 32_L, it can be seen from Table 2 that: the film layer (i.e., the first film layer (i.e., the film layer 31_1)) closest to the substrate 10 is a high refractive index layer, and the film layer (i.e., the fifty-fifth film layer (i.e., the film layer 31_K)) farthest from the substrate 10 is also a high refractive index layer; the film layer with the smallest thickness is the film layer (i.e., the fifty-fourth film layer (i.e., the film layer 32_L)) that is the second farthest from the substrate 10; the thickness of the film layer closest to the substrate 10 is greater than that of the film layer farthest from the substrate 10; the thickness of the film layer (i.e., the second film layer (i.e., the film layer 32_1)) that is the second closest to the substrate 10 is greater than that of the film layer that is the second farthest from the substrate 10; among two adjacent film layers, the thickness ratio of the film layer close to the substrate to the film layer away from the substrate is within the range of 0.30 to 2.70; and the thickness ratio of a low refractive index layer to a high refractive index layer adjacent to the low refractive index layer is within the range of 0.74 to 2.27.

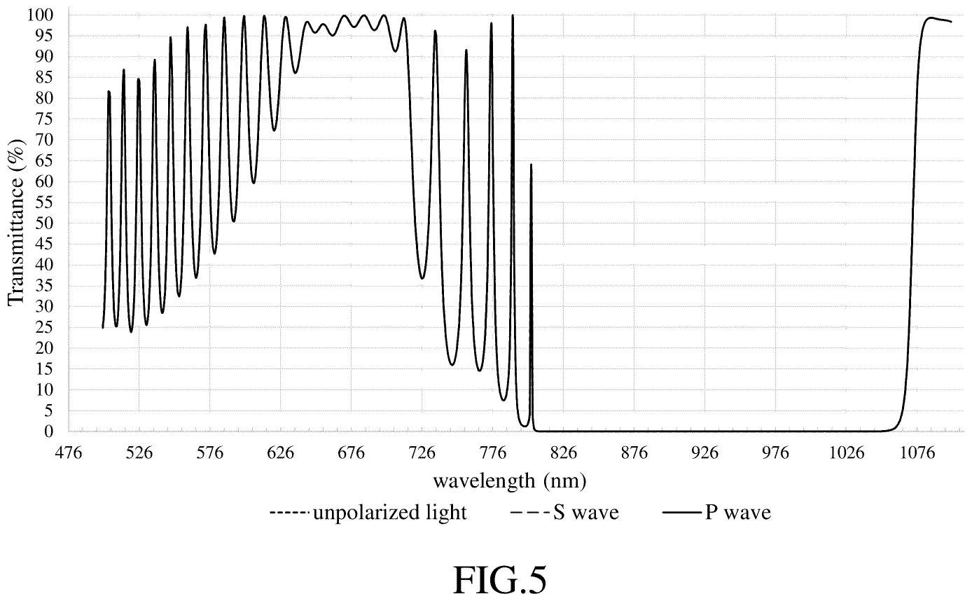

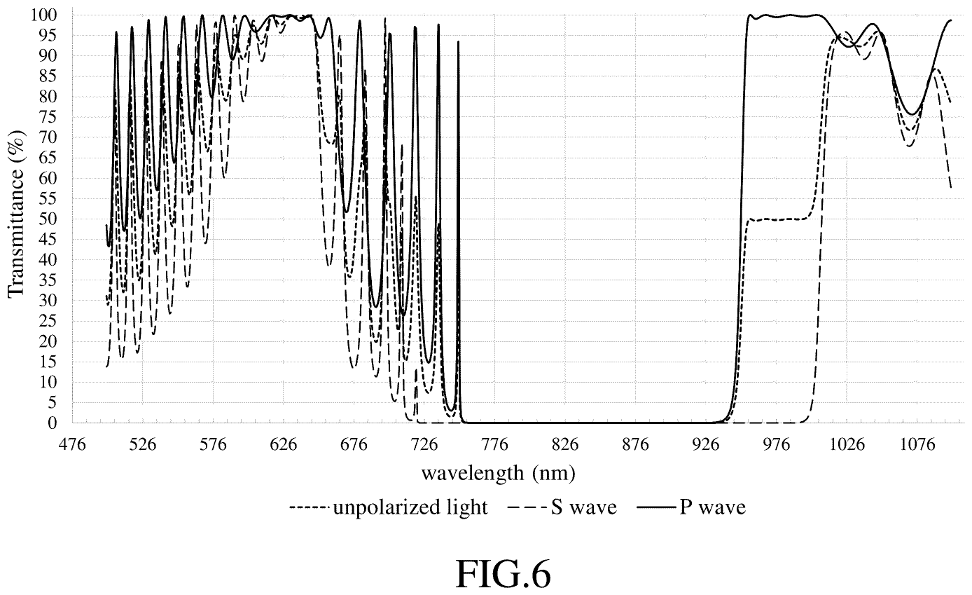

The following is a transmittance simulation test on the film stack structure of polarizing beam splitting 30 in Table 2. The film stack structure of polarizing beam splitting 30 is placed in an atmospheric environment, and then light with a reference wavelength of 550 nm is illuminated from above (i.e., above the drawing) at incident angles of 0° and 45° respectively, and the test results corresponding to the incident angle of 0° as shown in FIG. 5 and the test results corresponding to the incident angle of 45° as shown in FIG. 6 are obtained. The definitions of the spectral curves in FIGS. 5 and 6 are the same as those in FIGS. 2 and 3.

It can be seen from FIG. 5 that the spectral curves of unpolarized light, the S-wave (for example, the first polarized light), and the P-wave (for example, the second polarized light) completely coincide. The transmittance of unpolarized light, the S-wave, and the P-wave in the wavelength band from 805 nm to 1060 nm at an incident angle of 0 degree is lower than 1%, the transmittance in the wavelength band from 808 nm to 1052 nm at an incident angle of 0 degree is lower than 0.1%, and even the transmittance in the wavelength band from 813 nm to 1039 nm at an incident angle of 0 degree is 0%.

It can be seen from FIG. 6 that the transmittance of unpolarized light in the wavelength band from 752 nm to 941 nm at an incident angle of 45 degrees is lower than 1%, the transmittance in the wavelength band from 755 nm to 933 nm at an incident angle of 45 degrees is lower than 0.1%, and the transmittance in the wavelength band from 762 nm to 920 nm at an incident angle of 45 degrees is 0%. The transmittance of the S-wave in the wavelength band from 721 nm to 997 nm at an incident angle of 45 degrees is lower than 1%, the transmittance in the wavelength band from 723 nm to 990 nm at an incident angle of 45 degrees is lower than 0.1%, and even the transmittance in the wavelength band from 684 nm to 980 nm at an incident angle of 45 degrees is 0%. The transmittance of the P-wave in the wavelength band from 753 nm to 939 nm at an incident angle of 45 degrees is lower than 1%, the transmittance in the wavelength band from 756 nm to 930 nm at an incident angle of 45 degrees is lower than 0.1%, and even the transmittance in the wavelength band from 764 nm to 916 nm at an incident angle of 45 degrees is 0%. In particular, the transmittance of the S-wave in the wavelength band from 931 nm to 991 nm at an incident angle of 45 degrees is lower than 0.1%, while the transmittance of the P-wave in the wavelength band from 931 nm to 991 nm at an incident angle of 45 degrees is higher than 0.1%, and even the transmittance of the P-wave in the wavelength band from 956 nm to 991 nm at an incident angle of 45 degrees is as high as over 98%. Moreover, the transmittance T1 of the film stack structure of polarizing beam splitting 30 for the S-wave in the wavelength band from 723 nm to 991 nm at an incident angle of 45 degrees and the transmittance T2 of the film stack structure of polarizing beam splitting 30 for the P-wave in the wavelength band from 723 nm to 991 nm at an incident angle of 45 degrees satisfy the following conditional formula: T2/T1>1000.

It can be seen from this that unpolarized light in the wavelength band from 723 nm to 991 nm being projected onto the film stack structure of polarizing beam splitting 30 at an incident angle of 45 degrees could be split into the P-wave and the S-wave, and the S-wave will be reflected while the P-wave will pass through the film stack structure of polarizing beam splitting 30. In this way, an optical element using the film stack structure of polarizing beam splitting 30 can serve as a polarizing beam splitter that only allows the P-wave to pass through.

In summary, the film stack structure of polarizing beam splitting of the present invention not only splits unpolarized light into the P-wave and the S-wave to achieve the single polarization of the transmitted light by letting only one of the P-wave and the S-wave to be transmitted, but also owns a smaller volume, thereby broadening the applicability of the present. Even, the present invention may make the 100% transmittance of a specific type of polarized light in a specific wavelength band at an incident angle of 45 degrees become possible.

Although the present invention has been disclosed as above with the aforementioned embodiments, these embodiments are not intended to limit the present invention. Any changes, modifications and combinations of various implementation aspects made within the spirit and scope of the present invention all fall within the patent protection scope of the present invention. For the protection scope defined by the present invention, please refer to the attached claims.

What is claimed is:

1. A film stack structure of polarizing beam splitting, being suitable to be disposed on a substrate and comprising:
a plurality of film layers, including high refractive index layers and low refractive index layers, and the high refractive index layers and the low refractive index layers being alternately stacked on the substrate;
wherein a transmittance of the film stack structure of polarizing beam splitting for first polarized light in a specific wavelength band at an incident angle of 45 degrees is defined as T1, and a transmittance of the film stack structure of polarizing beam splitting for second polarized light in the specific wavelength band at an incident angle of 45 degrees is defined as T2, a polarization direction of the first polarized light is perpendicular to that of the second polarized light, and the following conditional formula is satisfied: T2/T1>1000.

2. The film stack structure of polarizing beam splitting as claimed in claim 1, wherein a transmittance of the film stack structure of polarizing beam splitting for the first polarized light in a wavelength band of 871 nm-927 nm at an incident angle of 45 degrees is lower than 0.1% while a transmittance of the film stack structure of polarizing beam splitting for the second polarized light in a wavelength band of 871 nm-927 nm at an incident angle of 45 degrees is higher than 0.1%.

3. The film stack structure of polarizing beam splitting as claimed in claim 1, wherein the number of high refractive index layers is greater than that of low refractive index layers.

4. The film stack structure of polarizing beam splitting as claimed in claim 1, wherein a film layer closest to the substrate among the plurality of film layers is the high refractive index layer, and a film layer farthest from the substrate among the plurality of film layers is also the high refractive index layer.

5. The film stack structure of polarizing beam splitting as claimed in claim 2, wherein a film layer with the largest thickness among the plurality of film layers is a film layer that is the second farthest from the substrate, among the plurality of film layers.

6. The film stack structure of polarizing beam splitting as claimed in claim 2, wherein a film layer with the smallest thickness among the plurality of film layers is a film layer farthest from the substrate among the plurality of film layers.

7. The film stack structure of polarizing beam splitting as claimed in claim 1, wherein a thickness of a film layer closest to the substrate among the plurality of film layers is greater than that of a film layer farthest from the substrate among the plurality of film layers.

8. The film stack structure of polarizing beam splitting as claimed in claim 2, wherein a thickness of a film layer that is the second closest to the substrate, among the plurality of film layers is smaller than that of a film layer that is the second farthest from the substrate, among the plurality of film layers.

9. The film stack structure of polarizing beam splitting as claimed in claim 2, wherein among two adjacent film layers of the plurality of film layers, a thickness ratio of the film layer close to the substrate to the film layer far from the substrate is within a range of 0.34-9.10.

10. The film stack structure of polarizing beam splitting as claimed in claim 2, wherein for a low refractive index layer and a high refractive index layer adjacent to the low refractive index layer among the plurality of film layers, a thickness ratio of the low refractive index layer to the high refractive index layer is within the range of 0.41-2.70.

11. The film stack structure of polarizing beam splitting as claimed in claim 1, wherein the high refractive index layers are titanium dioxide layers, and the low refractive index layers are silicon dioxide layers.

12. The film stack structure of polarizing beam splitting as claimed in claim 1, wherein a transmittance of the film stack structure of polarizing beam splitting for the first polarized light in a wavelength band of 931 nm-991 nm at an incident angle of 45 degrees is lower than 0.1% while a transmittance of the film stack structure of polarizing beam splitting for the second polarized light in a wavelength band of 931 nm-991 nm at an incident angle of 45 degrees is higher than 0.1%.

13. The film stack structure of polarizing beam splitting as claimed in claim 12, wherein a film layer with the smallest thickness among the plurality of film layers is a film layer that is the second farthest from the substrate, among the plurality of film layers.

14. The film stack structure of polarizing beam splitting as claimed in claim 12, wherein a thickness of a film layer that is the second closest to the substrate, among the plurality of film layers is greater than that of a film layer that is the second farthest from the substrate, among the plurality of film layers.

15. The film stack structure of polarizing beam splitting as claimed in claim 12, wherein among two adjacent film layers of the plurality of film layers, a thickness ratio of the film layer close to the substrate to the film layer far from the substrate is within the range of 0.30-2.70.

16. The film stack structure of polarizing beam splitting as claimed in claim 12, wherein for a low refractive index layer and a high refractive index layer adjacent to the low refractive index layer among the plurality of film layers, a thickness ratio of the low refractive index layer to the high refractive index layer is within the range of 0.74-2.27.

17. A polarizing beam splitter comprising a substrate and the film stack structure of polarizing beam splitting as described in claim 1, and the film stack structure of polarizing beam splitting being disposed on the substrate.
